(19) United States
(12) Patent Application Publication
(10) Pub. No.: US 2013/0135570 A1
(43) Pub. Date: May 30, 2013

(54) COMPOSITION FOR FORMING LIQUID CRYSTAL LAYER, LIQUID CRYSTAL DISPLAY DEVICE, AND METHOD FOR PRODUCING LIQUID CRYSTAL DISPLAY DEVICE

(71) Applicants: Masanobu Mizusaki, Osaka-shi (JP); Satoshi Enomoto, Tokyo (JP); Yuki Hara, Tokyo (JP)

(72) Inventors: Masanobu Mizusaki, Osaka-shi (JP); Satoshi Enomoto, Tokyo (JP); Yuki Hara, Tokyo (JP)

(73) Assignee: Toyo Gosei Co., Ltd., Chuo-ku, TOKYO (JP)

(21) Appl. No.: 13/814,025

(22) PCT Filed: Jul. 27, 2011
(86) PCT No.: PCT/JP2011/067052

§ 371 Date: Feb. 4, 2013

(51) Int. Cl. G02F 1/1337

(52) U.S. Cl. CPC G02F 1/133711
USPC 349/123

(57) ABSTRACT

The present invention provides a composition for forming a liquid crystal layer from which a liquid crystal display device hardly generating image sticking can be obtained. The composition for forming a liquid crystal layer according to the present invention contains a liquid crystal material and one or two or more monomers, wherein at least one of the monomers is a phenanthrene derivative represented by the following chemical formula (1):

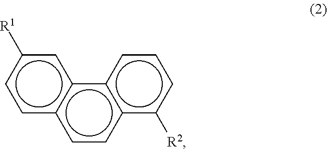

the following chemical formula (2):

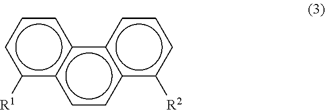

or the following chemical formula (3):

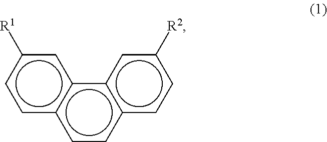

wherein R¹ and R² are identical or different, and each denote an -Sp-P group, a hydrogen atom, a halogen atom, a —CN group, a —NO₂ group, a —NCO group, a —NCS group, an —OCN group, a —SCN group, a —SF₅ group, or a straight-chain or branched-chain alkyl group having 1 to 12 carbon atoms; at least one of R¹ and R² denotes an -Sp-P group; P denotes a polymerizable group; Sp denotes a straight-chain, branched-chain or cyclic alkylene group or alkyleneoxy group having 1 to 6 carbon atoms, or a direct bond of both groups interposing Sp; a hydrogen atom which R¹ and R² have may be replaced by a fluorine atom or a chlorine atom; and a —CH₂— group which R¹ and R² have, unless oxygen atoms, sulfur atoms and nitrogen atoms are mutually adjacent, may be substituted with an —O— group, a —S— group, a —NH— group, a —CO— group, a —COO— group, a —OCO— group, an —O—COO— group, a —OCH₂— group, a —CH₂O— group, a —SCH₂— group, a —CH₂S— group, a —N(CH₃)— group, a —N(C₂H₅)— group, a —N(C₃H₇)— group, a —N(C₄H₅)— group, a —CF₂O— group, a —OCF₂— group, a —CF₂S— group, a —SCF₂— group, a —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, or a —OCO—CH═CH— group.

### TECHNICAL FIELD

The present invention relates to a composition for forming a liquid crystal layer, a liquid crystal display device, and a method for producing a liquid crystal display device. The present invention relates particularly to a composition for forming a liquid crystal layer which is for forming a polymer layer on an alignment film in order to sustain the alignment control force of a liquid crystal for a long time, a liquid crystal display device in which a polymer layer is formed on an alignment film, and a method for producing a liquid crystal display device which is suitable for forming a polymer layer on an alignment film.

### BACKGROUND ART

Since liquid crystal display devices are of thin profile, light weight and low power consumption, they are broadly used as display units such as televisions, personal computers and PDAs. Particularly in recent years, upsizing of liquid crystal display devices has been rapidly progressing, as represented by the case of liquid crystal display devices for televisions and the like. For upsizing, the multidomain vertical alignment mode (MVA: Multidomain Vertical Alignment) is suitably used which can be produced in a high yield even if the device has a large area, and has a wide view angle. The multidomain vertical alignment mode, since liquid crystal molecules are aligned vertically to a substrate surface at the time when a voltage is not impressed in a liquid crystal layer, can provide a higher contrast ratio than the conventional TN mode (TN: Twisted Nematic).

However, the MVA mode, since using ribs (protrusions), has a decreased aperture ratio and consequently has a drawback of a low white luminance. Although it suffices if the arrangement intervals of the ribs are made sufficiently large in order to improve this drawback, since the number of the ribs, which are a structure for controlling the alignment, becomes small, the time taken before the alignment stabilizes becomes long even if a predetermined voltage is impressed on a liquid crystal, thus posing a problem of elongating the response time. In order to improve such a problem and allow high luminance and high-speed response, a pre-tilt angle-imparting technology (hereinafter, also referred to as a PSA (Polymer Sustained Alignment: alignment sustention) layer) is proposed (see, for example, Patent Literatures 1 and 2). In the PSA technology, a liquid crystal composition in which polymerizable components (hereinafter, abbreviated to a monomer and the like) such as a monomer and an oligomer are mixed in a liquid crystal is enclosed between substrates, and the monomer and the like are polymerized in a state in which the liquid crystal molecules are tilted by impressing a voltage between the substrates. Thereby, the liquid crystal has a predetermined pre-tilt angle even if the voltage impression is eliminated, and a liquid crystal director can be established. The polymerization of the monomer and the like is carried out by heat or light (ultraviolet rays) irradiation. Use of the PSA technology makes ribs unnecessary and improves the aperture ratio, and simultaneously imparts a pre-tilt angle smaller than 90° over an entire display region, enabling high-speed response.

### CITATION LIST

### Patent Literature

Patent Literature 1: WO 2009/118086
Patent Literature 2: Chinese Patent No. 101008784

### SUMMARY OF INVENTION

### Technical Problem

However, as a result of studies by the present inventors, there occurred “image sticking” in display in some cases, when the same pattern was displayed for a long time by using the conventional PSA technology, even if a liquid crystal layer composition containing a liquid crystal material, a monomer, a polymerization initiator and the like was injected into a pair of substrates and a polymerization reaction was caused under a predetermined condition to thereby form a polymer layer to sustain an alignment control force on an alignment film. One of causes of image sticking is that since a direct current offset voltage is generated inside a cell because of the presence of substances (ions, radical generators and the like) having charges, the alignment state of a liquid crystal becomes different when a voltage is impressed from the outside.

The present inventors have variously studied causes generating image sticking on a liquid crystal display device, and have paid attention to components contained in a liquid crystal layer after the polymerization reaction. It was found that even after the completion of a series of polymerization reactions, an unreacted monomer, a polymerization initiator and the like remained in the liquid crystal layer, and it was also found that if substances easily chargeable such as an unreacted monomer and a polymerization initiator remained in a liquid crystal layer, the charges transferred to other substances by the influence of a back light unit light in the usual using mode after the completion, or the influence of an aging step for inspection after the assembly step, and generation of ionic impurities were easily caused, thus causing image sticking in liquid crystal display.

The present invention has been achieved in consideration of the above present situation, and an object of the present invention is to provide a composition for forming a liquid crystal layer from which a liquid crystal display device hardly generating image sticking can be obtained.

### Solution to Problem

The present inventors have variously studied methods capable of preventing image sticking, and have paid attention to a combination of a PSA layer formed on an alignment film and for sustention of the alignment control force, and the alignment film serving as an underlayer of the PSA layer.

FIG. 4 is a graph collectively showing a relationship between the absorbance (a.u.) of a monomer for reference and the transmittance (%) of an alignment film-formed substrate. FIG. 5 is a graph collectively showing a relationship of the absorbance (a.u.) of one example of the monomers of the present invention and the transmittance (%) of an alignment film-formed substrate. As shown in FIG. 4, although as a usual monomer (a monomer for reference), monomers are often used which generate radicals by irradiation with light having a wavelength of 320 nm or shorter, a substrate having an alignment film on the surface generally used for a liquid crystal display device is likely to hardly transmit light having a wavelength shorter than 330 nm by the influence of main and side chains of a polymer constituting the alignment film. On the other hand, many usual ultraviolet light sources emit light having a low emission intensity at 310 nm and a high emission intensity at 330 nm or longer. Therefore, in order to sufficiently photopolymerize the monomer for reference, a long-time or multiple irradiations with ultraviolet light at 310 nm need to be carried out. However, the long-time or multiple irradiations with such ultraviolet light advance the deterioration of constituting members (for example, an alignment film and a liquid crystal layer) of a liquid crystal display device, and causes defects such as image sticking in some cases. By contrast, in the case where the irradiation with ultraviolet rays for a short time is carried out in order to suspend the advancement of the deterioration of the alignment film and the liquid crystal layer, the monomer is not sufficiently polymerized to thereby make an incomplete PSA layer, and defects such as image sticking are caused in some cases. Then, the present inventors have paid attention to that for example, as shown in FIG. 5, use of a monomer absorbing light having a wavelength of 330 nm or longer can raise the light utilization efficiency, and have found that even a short-time and single irradiation can form a stable PSA layer. Specifically, the present inventors have found that the residual DC voltage in a liquid crystal layer can be made to be hardly generated, and consequently, the image sticking in display can be reduced, and have found out that the findings can successfully solve the above-mentioned problems, thus having led to the present invention.

As a result of studies of monomers effective for prevention of image sticking, the present inventors have found that compounds represented by the following chemical formulae (1) to (3) are suitable, and the compound is mixed in a composition for forming a liquid crystal layer as the monomer and irradiated with light to thereby form a PSA layer on an alignment film, whereby the residual DC voltage can be made to be hardly generated in the liquid crystal layer, and the image sticking in display can be reduced.

That is, one aspect of the present invention is a composition for forming a liquid crystal layer which contains a liquid crystal material and one or two or more monomers, wherein at least one of the monomers is a phenanthrene derivative represented by the following chemical formula (1):

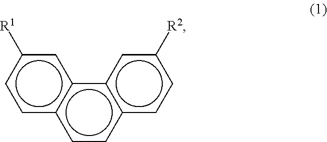

the following chemical formula (2):

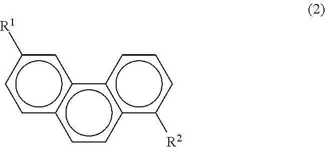

or the following chemical formula (3):

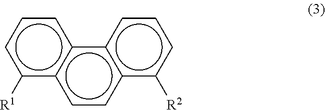

wherein R¹ and R² are identical or different, and each denote an -Sp-P group, a hydrogen atom, a halogen atom, a —CN group, a —NO₂ group, a —NCO group, a —NCS group, an —OCN group, a —SCN group, a —SF₅ group, or a straight-chain or branched-chain alkyl group having 1 to 12 carbon atoms; at least one of R¹ and R² denotes an -Sp-P group; P denotes a polymerizable group; Sp denotes a straight-chain, branched-chain or cyclic alkylene group or alkyleneoxy group having 1 to 6 carbon atoms, or a direct bond of both groups interposing Sp; a hydrogen atom which R¹ and R² have may be replaced by a fluorine atom or a chlorine atom; and a —CH₂— group which R¹ and R² have, unless oxygen atoms, sulfur atoms and nitrogen atoms are mutually adjacent, may be substituted with an —O— group, a —S— group, a —NH— group, a —CO— group, a —COO— group, a —OCO— group, an —O—COO— group, a —OCH₂— group, a —CH₂O— group, a —SCH₂— group, a —CH₂S— group, a —N(CH₃)— group, a —N(C₂H₅)— group, a —N(C₃H₇)— group, a —N(C₄H₉)— group, a —CF₂O— group, a —OCF₂— group, a —CF₂S— group, a —SCF₂— group, a —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH— COO— group, or a —OCO—CH═CH— group.

The above P is a polymerizable group, and the polymerization of the monomer is initiated with this moiety as a starting point. The polymerization reaction herein is not especially limited, and includes both of the “successive polymerization” in which bifunctional monomers are stepwise macromolecularized as forming new bonds, and the “chain polymerization” in which monomers successively bond to active species generated from a small amount of a catalyst (initiator), and chain-reactively grow. The successive polymerization includes polycondensation and polyaddition. The chain polymerization includes radical polymerization and ionic polymerization (anionic polymerization, cationic polymerization and the like). By causing a polymerization initiation species in the polymerizable monomer to be generated by light, the polymerization reaction can be initiated at normal temperature easily.

Monomers represented by the above chemical formulae (1) to (3), since being phenanthrene-based monomers and having the property of absorbing light having a wavelength of 330 nm or longer, can raise the light utilization efficiency, sufficiently forms a PSA layer even by a short-time and single irradiation and can make the residual DC voltage in a liquid crystal layer to be hardly generated. Since the light irradiation can be finished in a short time, the deterioration of constituting members due to the long-time light irradiation can be prevented, thereby allowing fabrication of a highly reliable liquid crystal display device.

Use of the composition for forming a liquid crystal layer of the present invention allows the formation of a polymer layer serving a function to reduce image sticking on an alignment film, for example, by filling the composition for forming a liquid crystal layer of the present invention between a pair of substrates, and photopolymerizing the monomer under a predetermined condition.

Comparing an anthracene compound having similarly three condensed aromatic rings and a phenanthrene compound used in the present invention, these are largely different in solubility in a liquid crystal material, and the solubility of an anthracene-based compound in a liquid crystal material is remarkably low. Specifically, whereas a phenanthrene-based monomer dissolves in 1 wt % or more in a liquid crystal material having a negative anisotropy of dielectric constant, an anthracene-based monomer can only dissolve in about 0.1 wt % or less.

The configuration of the composition for forming a liquid crystal layer of the present invention is not especially limited by other components as long as it essentially includes such components.

Preferable configurations of the composition for forming a liquid crystal layer of the present invention include the following configurations.

A configuration is included in which the above P denotes an acryloyloxy group, a methacryloyloxy group, an acryloylamino group, or a methacryloylamino group.

A configuration is included in which the above R¹ and R² are identical or different, and each denote an -Sp-P group, and one or both of the Sp denote a direct bond of both groups interposing the Sp.

A configuration is included in which the above R¹ and R² are identical or different, and each denote an acryloxy group or a methacryloxy group. Thereby, the effect of improving the polymerization velocity can be acquired.

The liquid crystal material includes a configuration having a negative anisotropy of dielectric constant. By using a liquid crystal material having a negative anisotropy of dielectric constant, in a state in which a voltage is not impressed in a liquid crystal layer, liquid crystal molecules sustain alignment approximately vertical to the substrate surface; and in a state in which a voltage equal to or higher than a threshold value is impressed in the liquid crystal layer, the liquid crystal molecules tilt to alignment approximately horizontal to the substrate surface. The liquid crystal mode of a liquid crystal display device to be fabricated can be thus made VA mode.

The present invention is also a liquid crystal display device suitably fabricated by using the composition for forming a liquid crystal layer of the present invention.

That is, another aspect of the present invention is a liquid crystal display device including a pair of substrates, and a liquid crystal layer sandwiched between the pair of substrates, wherein the liquid crystal layer contains a liquid crystal material; at least one of the pair of substrates has an alignment film to control the alignment of adjacent liquid crystal molecules, and a polymer layer formed on the alignment film and to control the alignment of adjacent liquid crystal molecules; and the polymer layer is a polymer layer formed by polymerizing one or two or more monomers added in the liquid crystal layer, and at least one of the monomers is a phenanthrene derivative represented by the following chemical formula (1):

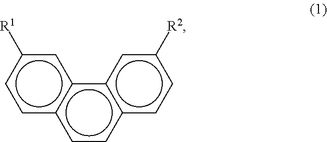

the following chemical formula (2):

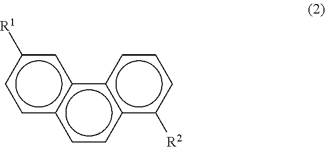

or the following chemical formula (3):

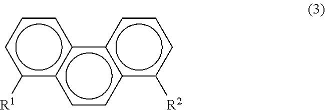

wherein R¹ and R² are identical or different, and each denote an -Sp-P group, a hydrogen atom, a halogen atom, a —CN group, a —NO₂ group, a —NCO group, a —NCS group, an —OCN group, a —SCN group, a —SF₅ group, or a straight-chain or branched-chain alkyl group having 1 to 12 carbon atoms; at least one of R¹ and R² denotes an -Sp-P group; P denotes a polymerizable group; Sp denotes a straight-chain, branched-chain or cyclic alkylene group or alkyleneoxy group having 1 to 6 carbon atoms, or a direct bond of both groups interposing Sp; a hydrogen atom which R¹ and R² have may be replaced by a fluorine atom or a chlorine atom; and a —CH₂— group which R¹ and R² have, unless oxygen atoms, sulfur atoms and nitrogen atoms are mutually adjacent, may be substituted with an —O— group, a —S— group, a —NH— group, a —CO— group, a —COO— group, a —OCO— group, an —O—COO— group, a —OCH₂— group, a —CH₂O— group, a —SCH₂— group, a —CH₂S— group, a —N(CH₃)— group, a —N(C₂H₅)— group, a —N(C₃H₇)— group, a —N(C₄H₉)— group, a —CF₂O— group, a —OCF₂— group, a —CF₂S— group, a —SCF₂— group, a —N(CF₂)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, or a —OCO—CH═CH— group.

In the pair of substrates which the liquid crystal display device of the present invention has, for example, one of the pair is used as an array substrate, and the other thereof is used as a color filter substrate. The array substrate has a plurality of pixel electrodes, by which the alignment of a liquid crystal is controlled in pixel units. In the color filter substrate, color filters of plural colors are arranged at positions superposed on the respective pixel electrodes of the array substrate, and the display colors are controlled in pixel units.

At least one of the pair of substrates which the liquid crystal display device of the present invention has an alignment film to control the alignment of adjacent liquid crystal molecules. In the present invention, the alignment film may be either one not having been subjected to an alignment treatment, or one having been subjected to an alignment treatment.

At least one of the pair of substrates which the liquid crystal display device of the present invention has a polymer layer formed on the alignment film and to control the alignment of adjacent liquid crystal molecules; and the polymer layer is a polymer layer formed by polymerizing one or two or more monomers added in a liquid crystal layer. By forming the polymer layer, even if the alignment film has not been subjected to an alignment treatment, liquid crystal molecules adjacent to the alignment film and the polymer layer can be initially tilted in a certain direction. For example, in the case where a monomer is polymerized in a state in which liquid crystal molecules are in a pre-tilt alignment to thereby form a polymer layer, the polymer layer results in being formed in a form having a structure causing a pre-tilt alignment on the liquid crystal molecules, irrespective of whether or not the alignment film has been subjected to an alignment treatment.

At least one of the above monomers is a condensed aromatic compound represented by the above chemical formula (1), (2) or (3). Monomers represented by the above chemical formulae (1) to (3), since being phenanthrene-based monomers and having the property of absorbing light having a wavelength of 330 nm or longer, can raise the light utilization efficiency, sufficiently forms a PSA layer even by a short-time and single irradiation and can make the residual DC voltage in a liquid crystal layer to be hardly generated. Since the light irradiation can be finished in a short time, the deterioration of constituting members due to the long-time light irradiation can be prevented, thereby enabling improvement of the reliability of a liquid crystal display device.

The constitution of the liquid crystal display device of the present invention is not especially limited by other constituting elements as long as the liquid crystal display device is formed essentially from such constituting elements.

Preferable configurations of the liquid crystal display device of the present invention include configurations similar to the content described above as preferable configurations of the composition for forming a liquid crystal layer of the present invention. That is, (i) a configuration is included in which the above P denotes an acryloyloxy group, a methacryloyloxy group, an acryloylamino group, or a methacryloylamino group; (ii) a configuration is included in which the above R¹ and R² are identical or different, and each denote an -Sp-P group, and one or both of the Sp denote a direct bond of both groups interposing the Sp; and (iii) a configuration is included in which the above R¹ and R² are identical or different, and each denote an acryloxy group or a methacryloxy group.

The above liquid crystal material includes a configuration having a negative anisotropy of dielectric constant. Hereinafter, other preferable configurations will be described.

A configuration is included in which the above alignment film is a vertical alignment film. A vertical alignment film refers to an alignment film to impart a pre-tilt angle of approximately 90° to liquid crystal molecules even if the alignment film has not been subjected to an alignment treatment, and has longer side chains than usual polymers. Since the use of a vertical alignment film can initially tilt liquid crystal molecules in an approximately vertical direction against the substrate surface, a liquid crystal display device of VA mode or the like can be provided.

A configuration is included in which the alignment film is constituted of a polyimide. Use of an imide structure in the main chain enables improvement of the thermal stability. A polyimide film can be formed, for example, by applying a polyimide in a solution state on a substrate, and thereafter subjecting the resultant to a desired heat treatment. In this case, the polyimide film may be formed by applying a thermoplastic polyimide in a solution state, and thereafter subjecting the resultant to a desired heat treatment, or applying a precursor of the polyimide in a polyamic acid state on a substrate, and subjecting the resultant to a heat treatment to imidize the resultant.

The present invention is also a method for producing a liquid crystal display device suitably fabricated by using the composition for forming a liquid crystal layer of the present invention.

That is, another aspect of the present invention is a method for producing a liquid crystal display device including a pair of substrates, and a liquid crystal layer sandwiched between the pair of substrates, wherein the method includes a step of forming an alignment film to control the alignment of adjacent liquid crystal molecules on at least one of the pair of substrates, and a step of forming a polymer layer to control the alignment of adjacent liquid crystal molecules on the alignment film, the step of forming a polymer layer includes a step of polymerizing one or two or more monomers added in the liquid crystal layer, and at least one of the monomers is a phenanthrene derivative represented by the following chemical formula (1):

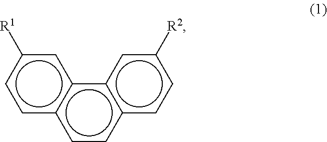

the following chemical formula (2):

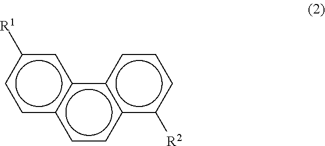

or the following chemical formula (3):

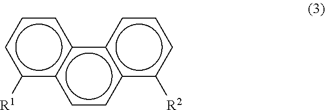

wherein R¹ and R² are identical or different, and each denote an -Sp-P group, a hydrogen atom, a halogen atom, a —CN group, a —NO₂ group, a —NCO group, a —NCS group, an —OCN group, a —SCN group, a —SF₅ group, or a straight-chain or branched-chain alkyl group having 1 to 12 carbon atoms; at least one of R¹ and R² denotes an -Sp-P group; P denotes a polymerizable group; Sp denotes a straight-chain, branched-chain or cyclic alkylene group or alkyleneoxy group having 1 to 6 carbon atoms, or a direct bond of both groups interposing Sp; a hydrogen atom which R¹ and R² have may be replaced by a fluorine atom or a chlorine atom; and a —CH₂— group which R¹ and R² have, unless oxygen atoms, sulfur atoms and nitrogen atoms are mutually adjacent, may be substituted with an —O— group, a —S— group, a —NH— group, a —CO— group, a —COO— group, a —OCO— group, an —O—COO— group, a —OCH₂— group, a —CH₂O— group, a —SCH₂— group, a —CH₂S— group, a —N(CH₃)— group, a —N(C₂H₅)— group, a —N(C₃H₇)— group, a —N(C₄H₉)— group, a —CF₂O— group, a —OCF₂— group, a —CF₂S— group, a —SCF₂— group, a —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH— COO— group, or a —OCO—CH═CH— group.

The features of a liquid crystal display device produced by the production method of the present invention are similar to the features of the above-mentioned liquid crystal display device of the present invention.

Monomers represented by the above chemical formulae (1) to (3), since being phenanthrene-based monomers and having the property of absorbing light having a wavelength of 330 nm or longer, can raise the light utilization efficiency, sufficiently forms a PSA layer even by a short-time and single irradiation and can make the residual DC voltage in a liquid crystal layer to be hardly generated. Since the light irradiation can be finished in a short time, the deterioration of constituting members due to the long-time light irradiation can be prevented.

The method for producing a liquid crystal display device of the present invention is not especially limited by other steps as long as the method essentially includes such steps.

Preferable configurations of the method for producing a liquid crystal display device of the present invention includes configurations similar to the content described above as preferable configurations of the composition for forming a liquid crystal layer or the liquid crystal display device of the present invention. That is, (i) a configuration is included in which the above P denotes an acryloyloxy group, a methacryloyloxy group, an acryloylamino group, or a methacryloylamino group; (ii) a configuration is included in which the above R¹ and R² are identical or different, and each denote an -Sp-P group, and one or both of the Sp denote a direct bond of both groups interposing the Sp; and (iii) a configuration is included in which the above R¹ and R² are identical or different, and each denote an acryloxy group or a methacryloxy group. Hereinafter, other preferable configurations will be described.

A configuration is included in which the step of forming a polymer layer is carried out in a state in which a voltage equal to or higher than a threshold value is impressed on a liquid crystal layer. By carrying out the light irradiation in a state in which a voltage equal to or higher than the threshold value is impressed on a liquid crystal layer in carrying out a PSA polymerization step, since a polymer is formed in a form conforming to liquid crystal molecules aligned in a state in which a voltage equal to or higher than the threshold value is impressed, the formed PSA layer results in having a structure functioning as an alignment film establishing an initial pre-tilt angle for liquid crystal molecules even if the state later becomes a state in which no voltage is impressed.

A configuration is included in which the step of forming a polymer layer is carried out in a state in which a voltage equal to or higher than a threshold value is not impressed on a liquid crystal layer. Even in a state in which a voltage equal to or higher than a threshold value is not impressed, the alignment control force of the alignment film can be sustained for a long time, and a certain effect of reducing image sticking can be acquired.

A configuration is included in which the step of forming an alignment film includes a step of carrying out an alignment treatment to thereby impart the alignment property of tilting by a certain angle from approximately 90° against the substrate surface. Thereby, the property of carrying out pre-tilt control can be imparted in which liquid crystal molecules are initially tilted by a certain angle from approximately 90° against a vertical alignment film tilting the liquid crystal molecules to approximately 90° against the substrate surface.

### Advantageous Effects of Invention

According to the composition for forming a liquid crystal layer of the present invention, a liquid crystal display device can be fabricated in which the generation of the image sticking based on a residual DC voltage is prevented. Also according to the liquid crystal display device of the present invention, since the generation of the image sticking based on a residual DC voltage is prevented, display excellent in display quality can be attained. Further according to the method for producing a liquid crystal display device of the present invention, a liquid crystal display device can be fabricated in which the generation of the image sticking based on a residual DC voltage is prevented to thereby provide an excellent display quality.

### BRIEF DESCRIPTION OF DRAWINGS

FIG. 1 is a cross-sectional illustrative diagram of a liquid crystal display device according to Embodiment 1, and shows one before a PSA polymerization step.

FIG. 2 is a cross-sectional illustrative diagram of the liquid crystal display device according to Embodiment 1, and shows one after the PSA polymerization step.

FIG. 3 is a graph showing absorption spectra of compounds represented by chemical formulae (4) to (6), and a transmission spectrum of a usual alignment film-formed substrate.

FIG. 4 is a graph collectively showing a relationship of the absorbance (a.u.) of a monomer for reference and the transmittance (%) of an alignment film-formed substrate.

FIG. 5 is a graph collectively showing a relationship of the absorbance (a.u.) of one example of the monomers of the present invention and the transmittance (%) of an alignment film-formed substrate.

FIG. 6 is a graph showing absorption spectra of compounds represented by chemical formulae (6) and (12), and a transmission spectrum of a usual alignment film-formed substrate.

### DESCRIPTION OF EMBODIMENTS

The present invention will be mentioned in more detail referring to the drawings in the following embodiments, but is not limited to these embodiments.

### Embodiment 1

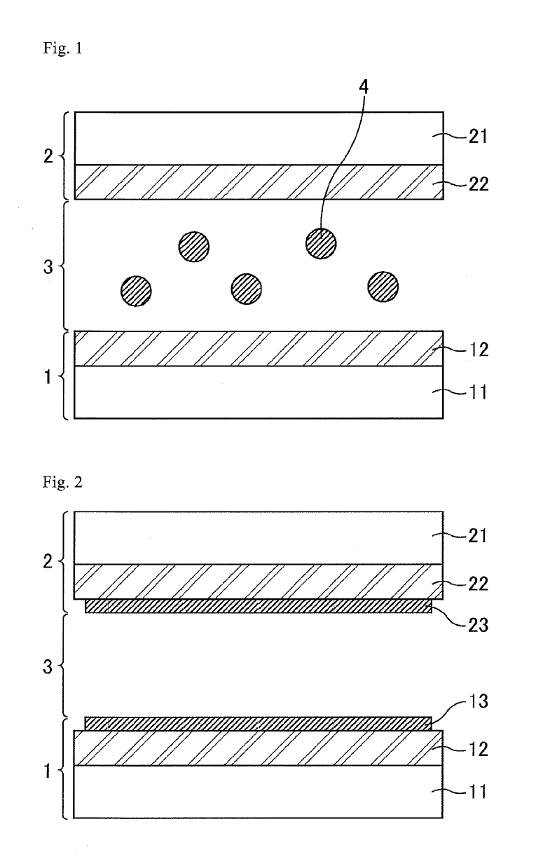

FIG. 1 and FIG. 2 are cross-sectional illustrative diagrams of a liquid crystal display device according to Embodiment 1. FIG. 1 shows one before the PSA polymerization step, and FIG. 2 shows one after the PSA polymerization step. As shown in FIG. 1 and FIG. 2, the liquid crystal display device according to Embodiment 1 has an array substrate 1, a color filter substrate 2 and a liquid crystal layer 3 interposed between a pair of substrates composed of the array substrate 1 and the color filter substrate 2. The array substrate 1 has a support substrate 11 having an insulating transparent substrate using a glass or the like as a material, and various types of wiring, pixel electrodes, TFTs (Thin Film Transistors) and the like formed on the transparent substrate. The color filter substrate 2 has a support substrate 21 having an insulating transparent substrate using a glass or the like as a material, and a color filter, a black matrix, common electrodes and the like formed on the transparent substrate.

The array substrate 1 has an alignment film 12 on the support substrate 11, and the color filter substrate 2 has an alignment film 22 on the support substrate 21. The alignment films 12 and 22 are constituted of a polymer material (polyimide) having a main chain containing an imide structure. For example, by using a vertical alignment film as the alignment films 12 and 22, even if the alignment treatment is not carried out, a pre-tilt angle of approximately 90° can be imparted to liquid crystal molecules. By carrying out an alignment treatment on the surface of the vertical alignment film, the pre-tilt angle of liquid crystal molecules can be tilted (initially tilted) by a certain angle from approximately 90°. For a vertical alignment film material, a compound is used which has longer side chains than usual polymers.

As shown in FIG. 1, in the liquid crystal layer 3 before the PSA polymerization step, one or two or more monomers 4 are present. Then, the polymerization of the monomers 4 is initiated by the PSA polymerization step to thereby form PSA layers 13 and 23 on the alignment films 12 and 22, respectively as shown in FIG. 2.

Specifically, the PSA layers 13 and 23 can be formed by injecting a composition for forming a liquid crystal layer containing one or two or more monomers 4 and a liquid crystal material having a negative anisotropy of dielectric constant between the array substrate 1 and the color filter substrate 2 to thereby form a liquid crystal layer, and for example, irradiating the liquid crystal layer 3 with a certain amount of light to thereby photopolymerize the monomers 4. Although FIG. 2 is illustrated as a diagram showing the PSA layer formed all over the surface of the alignment film, actually the alignment film may be formed dotwise plurally, and the film thickness may have a variation.

Since the monomer 4 used in Embodiment 1 absorbs light as the monomer 4 alone, generates radicals and initiates the chain polymerization, there is no need to add a polymerization initiator.

In Embodiment 1, for example, by carrying out the light irradiation in a state in which a voltage equal to or higher than a threshold value is impressed on the liquid crystal layer 3 in carrying out the PSA polymerization step, since a polymer is formed in a form conforming to liquid crystal molecules aligned in a state in which a voltage equal to or higher than the threshold value is impressed, the formed PSA layer results in having a structure functioning as an alignment film establishing an initial pre-tilt angle for liquid crystal molecules even if the state later becomes a state in which no voltage is impressed.

In Embodiment 1, the light irradiation may not be carried out in a state in which a voltage equal to or higher than a threshold value is impressed. For example, in the case where the alignment films 12 and 22 themselves have the property of imparting a pre-tilt alignment to liquid crystal molecules, the PSA layers 13 and 23 formed on the alignment films 12 and 22, respectively function as a film more raising the alignment stability which the alignment films have. Thereby, the alignment control force is sustained for a long time, thereby making the temporal change of the alignment small and besides, hardly generating the image sticking in display. In Embodiment 1, in addition to the alignment treatment on the alignment films 12 and 22, the light irradiation may be further carried out in a state in which a voltage equal to or higher than a threshold value is impressed on the liquid crystal layer 3 to thereby form the PSA layers 13 and 23; thereby, a combination of the films having a higher alignment stability can be provided.

Embodiment 1 may be a configuration in which the alignment of liquid crystal molecules is established, for example, by linear slits provided in the pixel electrodes which the support substrate 11 has or in the common electrodes which the support substrate 21 has. In the case where fine linear slits are formed in pixel electrodes and/or common electrodes, since liquid crystal molecules have the alignment property of aligning uniformly toward the linear slits in the time of voltage impression, a PSA layer to impart a pre-tilt angle to the liquid crystal molecules can be formed even if the alignment treatment has not been carried out on the alignment film.

A monomer used in Embodiment 1 is one to generate radicals by the irradiation with light having a wavelength of 330 to 370 nm, and is a phenanthrene derivative represented by the following chemical formula (1):

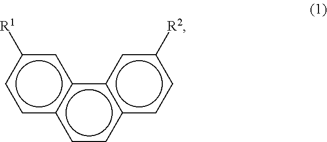

the following chemical formula (2):

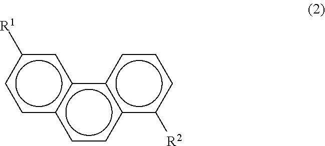

or the following chemical formula (3):

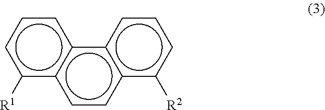

wherein R¹ and R² are identical or different, and each denote an -Sp-P group, a hydrogen atom, a halogen atom, a —CN group, a —NO₂ group, a —NCO group, a —NCS group, an —OCN group, a —SCN group, a —SF₅ group, or a straight-chain or branched-chain alkyl group having 1 to 12 carbon atoms; at least one of R¹ and R² denotes an -Sp-P group; P denotes a polymerizable group; Sp denotes a straight-chain, branched-chain or cyclic alkylene group or alkyleneoxy group having 1 to 6 carbon atoms, or a direct bond of both groups interposing Sp; a hydrogen atom which R¹ and R² have may be replaced by a fluorine atom or a chlorine atom; and a —CH₂— group which R¹ and R² have unless oxygen atoms, sulfur atoms and nitrogen atoms are mutually adjacent, may be substituted with an —O— group, a —S— group, a —NH— group, a —CO— group, a —COO— group, a —COO— group, an —O—COO— group, a —OCH₂— group, a —CH₂O— group, a —SCH₂— group, a —CH₂S— group, a —N(CH₃)— group, a —N(C₂H₅)— group, a —N(C₃H₇)— group, a —N(C₄H₉)— group, a —CF₂O— group, a —OCF₂— group, a —CF₂S— group, a —SCF₂— group, a —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, or a —OCO—CH═CH— group.

The monomers represented by the above chemical formulae (1) to (3) are preferably bifunctional monomers. The bifunctional monomers can form a more stable PSA layer than monofunctional monomers, when being mixed with a liquid crystal material. Since a substrate having an alignment film on the surface generally used for a liquid crystal display device is likely to absorb much of light shorter than 330 nm by the influence of main and side chains of a polymer constituting the alignment film, use of a monomer absorbing light of 330 nm or longer can raise the light utilization efficiency. Since phenanthrene compounds being three-benzene rings-condensed aromatics as represented by the above chemical formulae (1) to (3) have an absorption wavelength region on the longer wavelength side than 330 nm, the polymerization velocity using ultraviolet irradiation can be thereby raised and a stable PSA layer can be fabricated. In Embodiment 1, other monomers may be added in a composition for forming a liquid crystal layer, and the effect of reducing the image sticking can be acquired similarly.

Other constituting elements of the liquid crystal display device according to Embodiment 1 will be described in detail.

In the liquid crystal display device according to Embodiment 1, the array substrate 1, the liquid crystal layer 3 and the color filter substrate 2 are stacked in this order from the rear surface side of the liquid crystal display device to the observation surface side. On the rear surface side of the support substrate 11 which the array substrate 1 has, a polarizing plate is provided. Also on the observation surface side of the support substrate 21 which the color filter substrate 2 has, a polarizing plate is provided. On these polarizing plates, retardation plates may be further arranged; and the polarizing plates may be a circular polarization plate.

The liquid crystal display device according to Embodiment 1 may be any of a transmission type, a reflection type and a reflection/transmission-combined type. If the liquid crystal display device according to Embodiment 1 is of a transmission type or a reflection/transmission-combined type, the liquid crystal display device further has a back light unit. The back light unit is arranged on the further rear surface side of the array substrate 1, and arranged so that light is transmitted through the array substrate 1, the liquid crystal layer 3 and the color filter substrate 2 in this order. If the liquid crystal display device is of a reflection type or a reflection/transmission-combined type, the array substrate 1 has a reflector to reflect external light. At least in a region using reflected light as display, the polarizing plate of the color filter substrate 2 needs to be a circular polarization plate having a so-called λ/4 retardation plate.

The liquid crystal display device according to Embodiment 1 may have a configuration of a Color Filter On Array having a color filter on the array substrate 1. The liquid crystal display device according to Embodiment 1 may be of a monochromatic display type, and in this case, the color filter does not need to be arranged.

In the liquid crystal layer 3, a liquid crystal material is filled which has the property of aligning in a specific direction by impression of a certain voltage. The alignment property of liquid crystal molecules in the liquid crystal layer 3 is controlled by impression of a voltage equal to or higher than a threshold value. In Embodiment 1, liquid crystal molecules behave as the VA mode.

The liquid crystal display device according to Embodiment 1 can be checked for the analysis of components of the alignment film, the analysis of components of monomers for forming a PSA layer present in the PSA layer, the mingling amount of the monomers for forming a PSA layer contained in the liquid crystal layer, the presence ratios of the monomers for forming a PSA layer present in the PSA layer, and the like by disassembling the liquid crystal display device (for example, liquid crystal TV (television) and DID (digital information display), and carrying out chemical analyses using Nuclear Magnetic Resonance (NMR), Fourier Transform Infrared Spectroscopy (FT-IR), Mass Spectrometry (MS), and the like.

### EXAMPLES

### Example 1

Hereinafter, Example 1 will be shown in which liquid crystal cells which the liquid crystal display devices according to Embodiment 1 had were each actually fabricated. First, a pair of support substrates were prepared; and a polyamic acid solution being a material for a vertical alignment film was applied on the respective surfaces of the pair of support substrates, and pre-baked under a condition of 80° C. for 5 min, and then post-baked under a condition of 200° C. for 60 min.

Then, the alignment films after the post-baking were subjected to an alignment treatment. Then, a sealant was applied on the one substrate; and a composition for forming a liquid crystal layer containing a liquid crystal material having a negative anisotropy of dielectric constant and monomers for forming a PSA layer was dropped on the one substrate; and thereafter, the other substrate was laminated.

In Example 1, monomers are used as a combination of monomers represented by the following chemical formulae (4) to (6). A compound represented by the following chemical formula (4) is a phenanthrene-based bifunctional methacrylate monomer; a compound represented by the following chemical formula (5) is a phenanthrene-based bifunctional methacrylate monomer; and a compound represented by the following chemical formula (6) is a biphenyl-based bifunctional methacrylate monomer.

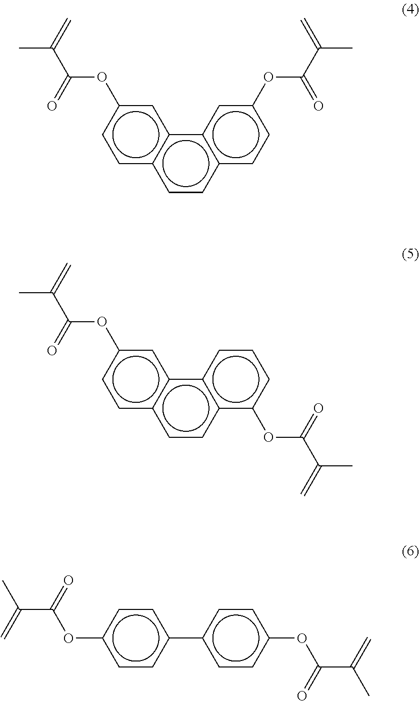

In order to fabricate the liquid crystal cell shown in Example 1, the compounds represented by the above chemical formulae (4) and (5) to be used as monomers for forming a PSA layer were synthesized. The above compounds were synthesized according to methods shown hereinafter, but the methods are not limited thereto.

### Synthesis Example 1

### Synthesis of 1,6-dimethacryloyloxyphenanthrene (the Above Chemical Formula (5)))

### [Step 1] Synthesis of (4-bromobenzyl)triphenylphosphonium-bromide

8 g of 4-bromobenzyl bromide and 8.4 g of triphenylphosphine were dissolved in 194 g of toluene, and stirred at a reflux temperature for 4 hours. Thereafter, the stirred solution was cooled to 15° C., and a deposit was filtered. Thereafter, the filtered residue was washed with 16 g of cyclohexane, and further vacuum dried to thereby obtain 15.6 g of (4-bromobenzyl)triphenylphosphonium-bromide as a target. The reaction path herein is represented by the following chemical reaction formula (7).

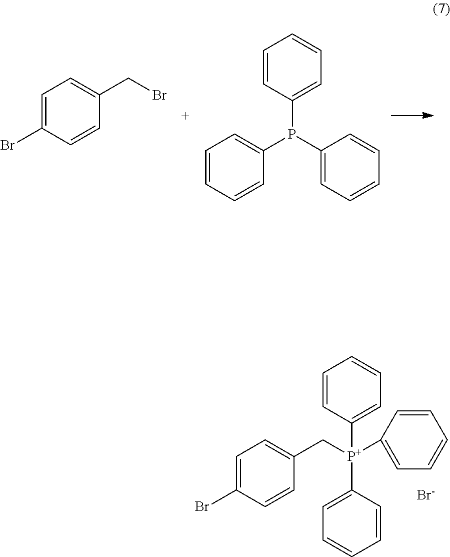 [SMILES: BrCc1ccc(Br)cc1 ; c1ccc(P(c2ccccc2)c2ccccc2)cc1 ; Brc1ccc(C[P+](c2ccccc2)(c2ccccc2)c2ccccc2)cc1 ; [Br-]]

### [Step 2] Synthesis of 2,4′-dibromostilbene

15.6 g of the (4-bromobenzyl)triphenylphosphonium-bromide and 5.5 g of 2-bromobenzaldehyde were dissolved in 311 g of methylene chloride. Then, to the solution, 13.4 g of a 45%-NaOH aqueous solution was dropped over 30 min. After the dropping, the resultant solution was stirred at room temperature for 15 hours. After the stirring, 153 g of water was added thereto to separate the resultant liquid. Further, the obtained methylene chloride layer was washed with water to neutralize the methylene chloride layer; and the methylene chloride as the solvent was distilled away. 156 g of cyclohexane was added to a residue after the distilling-away to thereby deposit triphenylphosphine oxide. Then, the solution containing the deposited component was filtered, and the cyclohexane as the solvent was distilled away to thereby obtain 5.9 g of 2,4′-dibromostilbene as a target substance. The reaction path herein is represented by the following chemical reaction formula (8).

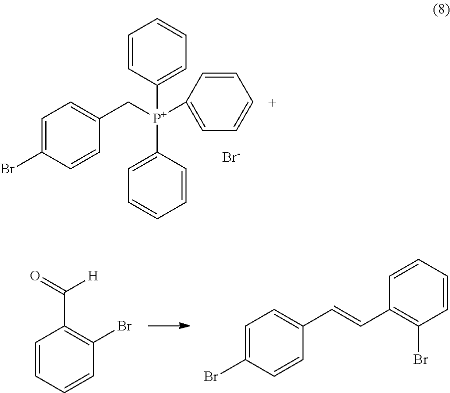 [SMILES: Brc1ccc(C[P+](c2ccccc2)(c2ccccc2)c2ccccc2)cc1 ; [Br-] ; O=Cc1ccccc1Br ; Brc1ccc(/C=C/c2ccccc2Br)cc1]

### [Step 3] Synthesis of 1,6-dibromophenanthrene

5.9 g of the 2,4′-dibromostilbene was dissolved in 765 g of benzene. Then, in the solution, 0.038 g of iodine was dissolved. After the dissolving, the resultant solution was irradiated with light for 10 days using a mercury xenon lamp (LIGHTINGCURE L8333, made by Hamamatsu Photonics K.K.). After the light irradiation, benzene as the solvent was distilled away. An obtained residue was recrystallized in a mixed solvent of ethanol/toluene, and dried to thereby obtain 3.1 g of 1,6-dibromophenanthrene as a target substance. The reaction path herein is represented by the following chemical reaction formula (9).

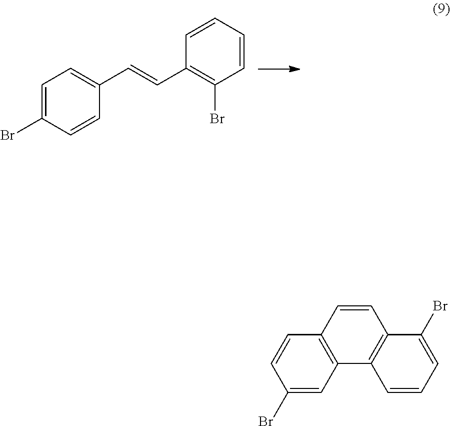 [SMILES: Brc1ccc(/C=C/c2ccccc2Br)cc1 ; Brc1ccc2ccc3c(Br)cccc3c2c1]

### [Step 4] Synthesis of 1,6-dihydroxyphenanthrene

20 g of NaOH was added and dissolved in 40 g of water. Then, the solution was put in an autoclave; and 2.6 g of CuSO₄, 2.6 g of Cu and 3.1 g of the 1,6-dibromophenanthrene were added to the autoclave, which was then closed. After deaeration with nitrogen, the resultant was stirred at 240° C. for 8 hours. Thereafter, the content was cooled to room temperature, and filtered. Then, the filtrate was dropped in 650 g of a 10%-H₂SO₄ aqueous solution to thereby subject the filtrate to an acid deposition. Then, the solution after the acid deposition was filtered and the residue was washed with water and dried. After the drying, the resultant was subjected to silica gel column chromatography (ethyl acetate:hexane=1:5) to thereby obtain 1.2 g of 1,6-dihydroxyphenanthrene as a target substance. The reaction path herein is represented by the following chemical reaction formula (10).

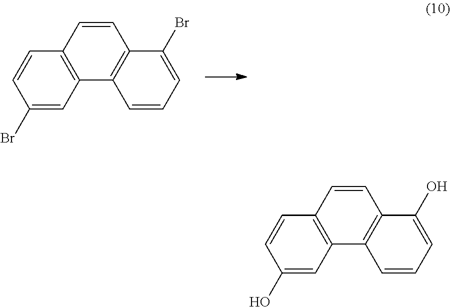 [SMILES: Brc1ccc2ccc3c(Br)cccc3c2c1 ; Oc1ccc2ccc3c(O)cccc3c2c1]

### [Step 5] Synthesis of 1,6-dimethacryloyloxyphenanthrene

1.2 g of the 1,6-dihydroxyphenanthrene was dissolved in 24 g of THF, and 1.5 g of methacrylic acid chloride was added thereto. After the addition, a solution in which 1.4 g of triethylamine was dissolved in 8.8 g of THF was dropped over 30 min. Then, the solution after the dropping was stirred for 1 hour. Thereafter, 85 g of a 1%-HCl aqueous solution was added to the stirred solution, thereafter extracted with 48 g of methylene chloride, and separated and washed with water. Thereafter, methylene chloride was distilled away, and the resultant was refined by silica gel column chromatography (ethyl acetate:hexane=1:9) to thereby obtain 1,6-dimethacryloyloxyphenanthrene as a target substance. The yield was 1.7 g. The reaction path herein is represented by the following chemical reaction formula (11).

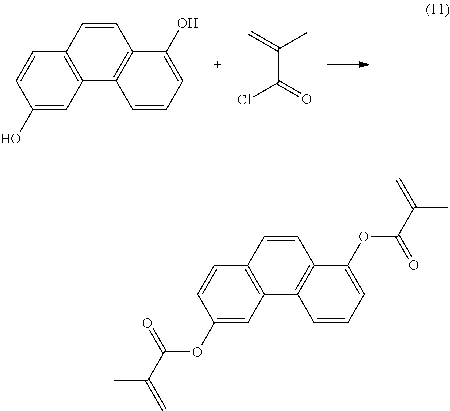

The analysis result of the obtained compound is as follows, and the compound was confirmed to be 1,6-dimethacryloyloxyphenanthrene by ¹H-NMR.

¹H-NMR (CDCl₃, ppm): δ=2.14 (s, 3H, methyl group), 2.18 (s, 3H, methyl group), 5.83 (s, 1H, vinyl group), 5.89 (s, 1H, vinyl group), 6.46 (s, 1H, vinyl group), 6.55 (s, 1H, vinyl group), 7.42 (m, 2H, phenanthrene ring), 7.65 (t, 1H, phenanthrene ring), 7.76 (d, 1H, phenanthrene ring), 7.79 (d, 1H, phenanthrene ring), 7.92 (d, 1H, phenanthrene ring), 8.41 (s, 1H, phenanthrene ring), 8.49 (d, 1H, phenanthrene ring)

### Synthesis Example 2

### Synthesis of 3,6-dimethacryloyloxyphenanthrene (the Above Chemical Formula (4)))

3,6-Dimethacryloyloxyphenanthrene as a target substance was synthesized and obtained according to the above synthesis method of the 1,6-dimethacryloyloxyphenanthrene, except for using 4-bromobenzaldehyde in [Step 2] in the above Synthesis Example 1.

The analysis result of the obtained compound is as follows, and the compound was confirmed to be 3,6-dimethacryloyloxyphenanthrene by ¹H-NMR.

¹H-NMR (CDCl₃, ppm): δ=2.13 (s, 6H, methyl group), 5.82 (s, 2H, vinyl group), 6.44 (s, 2H, vinyl group), 7.40 (d, 2H, phenanthrene ring), 7.73 (s, 2H, phenanthrene ring), 7.92 (s, 2H, phenanthrene ring), 8.31 (d, 2H, phenanthrene ring)

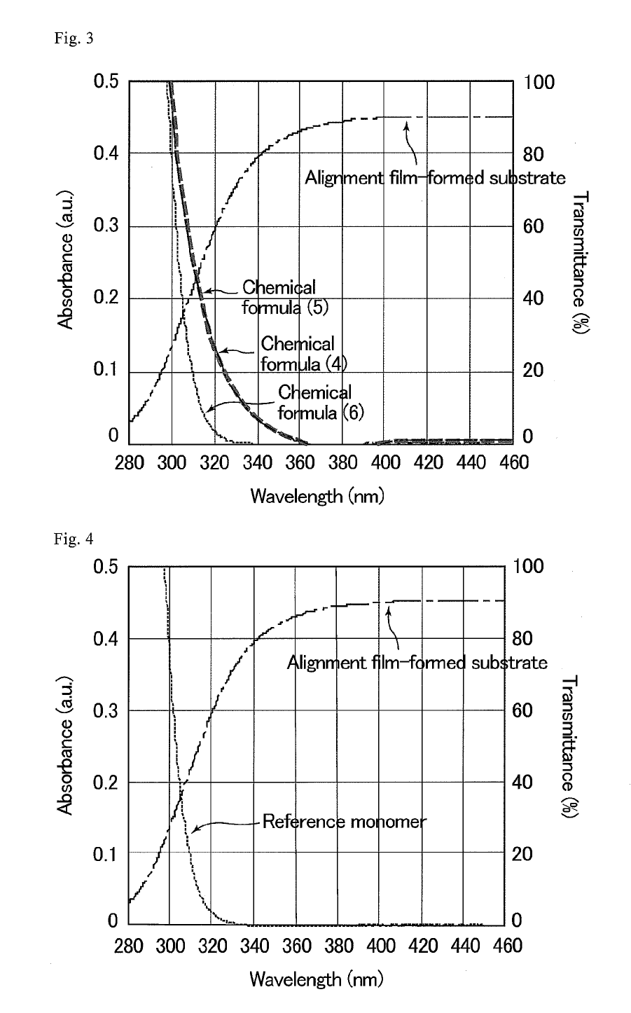

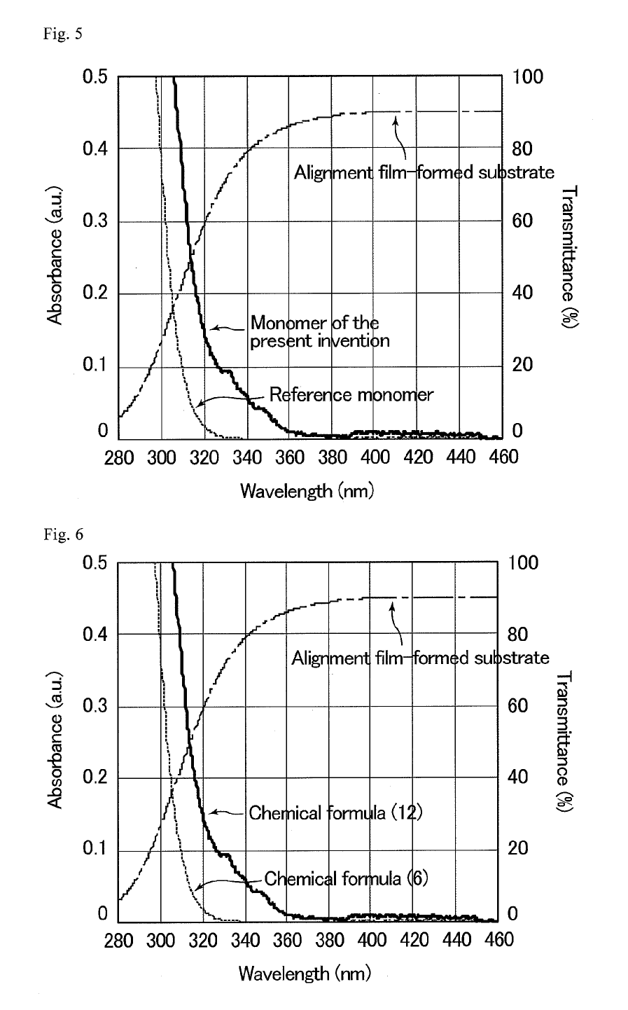

FIG. 3 is a graph showing absorption spectra of compounds represented by the above chemical formulae (4) to (6), and a transmission spectrum of a usual alignment film-formed substrate. A compound represented by the above chemical formula (6) absorbs light of shorter wavelengths with a wavelength of 320 nm as the upper limit. On the other hand, compounds represented by the above chemical formulae (4) and (5) absorb light of shorter wavelengths with a wavelength of 365 nm as the upper limit. Therefore, the compounds represented by the above chemical formulae (4) and (5) can absorb light of wavelengths of 330 to 365 nm, which is not absorbed by the compound represented by the above chemical formula (6), and can be said to have a wider absorption wavelength range than the compound represented by the above chemical formula (6). The compounds represented by the above chemical formulae (4) and (5) both have a phenanthrene skeleton, and have substantially the same light absorption property.

The alignment film-formed substrate used herein refers to a substrate in which an ITO (indium tin oxide) film is formed on a glass substrate, and an alignment film is formed on the ITO film. The transmittance of a usual alignment film-formed substrate is such that light of shorter wavelengths than a wavelength of 340 nm is hardly transmitted.

From the above, in the case where the PSA treatment is carried out by light irradiation in a liquid crystal layer through a usual alignment film-formed substrate, single use of a compound represented by the above chemical formula (6) results in a long time taken before the polymerization reaction is completely finished.

Samples prepared in Example 1 are the following Samples A to C. Sample A contains 0.6 wt % of a bifunctional phenanthrene-based monomer represented by the above chemical formula (4) in a composition for forming a liquid crystal layer. Sample B contains 0.6 wt % of a bifunctional phenanthrene-based monomer represented by the above chemical formula (5) in a composition for forming a liquid crystal layer. Sample C contains 0.3 wt % of a bifunctional biphenyl-based monomer represented by the above chemical formula (6) in a composition for forming a liquid crystal layer.

Then, the liquid crystal layer sandwiched between the pair of substrates was irradiated with black light (ultraviolet light having a peak wavelength in 300 to 370 nm) in a state in which a voltage was not impressed to carry out the polymerization reaction to thereby complete each liquid crystal cell in which a PSA layer was formed on the vertical alignment film. The irradiation time of ultraviolet rays to Sample A and Sample B was set for 30 min, and that to Sample C was set for 60 min. As an ultraviolet light source, FHF-32BLB made by Toshiba Lighting & Technology Corp. was used. FHF-32BLB was an ultraviolet light source having a low emission intensity at 310 nm and a high emission intensity at 330 nm or longer.

Then, for each completed liquid crystal cell, the residual DC voltage (mV) was measured. Hereinafter, the results of the measurement of the residual DC voltage for each Sample are shown. Table 1 shows the measurement results of the residual DC voltage (mV) using the above each Sample. In Example 1, the value of a residual DC voltage is determined by using a flicker minimizing method after a DC offset voltage of 2 V is impressed for 10 hours.

TABLE 1

| | | Residual DC voltage |
|---|---|---|
| | Composition weight ratio | (mV) |
| Sample A | Chemical formula (4) - 0.6 | 70 |
| | wt % | |
| Sample B | Chemical formula (5) - 0.6 | 80 |
| | wt % | |
| Sample C | Chemical formula (6) - 0.3 | 170 |
| | wt % | |

Use of the composition containing 0.6 wt % of a bifunctional phenanthrene-based monomer represented by the above chemical formula (4) reduced the residual DC voltage to as low as 70 mV, and attained an improving effect of after image of image sticking. Use of the composition containing 0.6 wt % of a bifunctional phenanthrene-based monomer represented by the above chemical formula (5) also reduced the residual DC voltage to as low as 80 mV, and attained an improving effect of after image of image sticking. This is because the use of bifunctional phenanthrene-based monomers represented by the above chemical formulae (4) and (5) can raise the polymerization velocity by ultraviolet light irradiation, forms a PSA layer by ultraviolet rays irradiation in a shorter time than conventionally, and prevents the deterioration of constituting members.

In the case of the composition containing 0.3 wt % of a bifunctional biphenyl-based monomer represented by the above chemical formula (6), a long-time irradiation with ultraviolet light (for example, 10 hours or longer) was necessary and the irradiation for 60 min could not form a stable PSA layer, and the residual DC voltage was 170 mV.

Since the monomer represented by the above chemical formula (4) or (5) has the property of absorbing light having a wavelength of 330 nm or longer, the light utilization efficiency can be raised, and a PSA layer is sufficiently formed even by a short-time and single irradiation, and the residual DC voltage in the liquid crystal layer can be made to be hardly generated. Since the light irradiation can be finished in a short time, the deterioration of constituting members due to the long-time light irradiation can be prevented.

In the case where a PSA layer is formed using a compound represented by the above chemical formula (4) or (5), since the polymerization reaction is carried out using no polymerization initiator, the PSA layer exhibits no variation in the display property due to the influence of the residual unreacted polymerization initiator. Therefore, the generation of the image sticking in display due to the unreacted polymerization initiator can be reduced.

From the above, it was found that the formation of a PSA layer by using a bifunctional phenanthrene-based monomer represented by the above chemical formula (4) or (5) was effective for the improvement of the generation of after image of image sticking.

### Example 2

Hereinafter, Example 2 will be shown in which liquid crystal cells which the liquid crystal display devices according to Embodiment 1 had were each actually fabricated. Each Sample of the liquid crystal cell used in Example 2 is fabricated by the same method as in Example 1, except for not subjecting the alignment film to an alignment treatment, and carrying out the irradiation with light in a state in which a voltage equal to or higher than a threshold value is impressed when a PSA layer is formed.

Samples prepared in Example 2 are the following Samples D to F. Sample D contains 0.6 wt % of a bifunctional phenanthrene-based monomer represented by the above chemical formula (4) in a composition for forming a liquid crystal layer. Sample E contains 0.6 wt % of a bifunctional phenanthrene-based monomer represented by the above chemical formula (5) in a composition for forming a liquid crystal layer. Sample F contains 0.3 wt % of a bifunctional biphenyl-based monomer represented by the above chemical formula (6) in a composition for forming a liquid crystal layer.

Then, the liquid crystal layer sandwiched between the pair of substrates was irradiated with black light (ultraviolet light having a peak wavelength in 300 to 370 nm) in a state in which a voltage (a square wave voltage of 5 V and 30 Hz) equal to or higher than a threshold value was impressed to carry out the polymerization reaction to thereby complete each liquid crystal cell in which a PSA layer was formed on the vertical alignment film. The irradiation time of ultraviolet rays to Sample D and Sample E was set for 30 min, and that to Sample F was set for 60 min. As an ultraviolet light source, FHF-32BLB made by Toshiba Lighting & Technology Corp. was used.

Then, for each completed liquid crystal cell, the residual DC voltage (mV) was measured. Hereinafter, the results of the measurement of the residual DC voltage for each Sample are shown. Table 2 shows the measurement results of the residual DC voltage (mV) using the above each Sample. In Example 2, the value of a residual DC voltage is determined by using a flicker minimizing method after a DC offset voltage of 2 V is impressed for 10 hours.

TABLE 2

| | | Residual DC voltage |
|---|---|---|
| | | (mV) |
| Sample D | Chemical formula (4) - 0.6 | 80 |
| | wt % | |
| Sample E | Chemical formula (5) - 0.6 | 80 |
| | wt % | |
| Sample F | Chemical formula (6) - 0.3 | 190 |
| | wt % | |

Use of the composition containing 0.6 wt % of a bifunctional phenanthrene-based monomer represented by the above chemical formula (4) reduced the residual DC voltage to as low as 80 mV, and attained an improving effect of after image of image sticking. Use of the composition containing 0.6 wt % of a bifunctional phenanthrene-based monomer represented by the above chemical formula (5) also reduced the residual DC voltage to as low as 80 mV, and attained an improving effect of after image of image sticking. This is because the use of bifunctional phenanthrene-based monomers represented by the above chemical formula (4) or (5) can raise the polymerization velocity by ultraviolet light irradiation, forms a PSA layer by ultraviolet rays irradiation in a shorter time than conventionally, and prevents the deterioration of constituting members.

In the case of the composition containing 0.3 wt % of a bifunctional biphenyl-based monomer represented by the above chemical formula (6), a long-time irradiation with ultraviolet light (for example, 10 hours or longer) was necessary and the irradiation for 60 min could not form a stable PSA layer, and the residual DC voltage was 190 mV.

Since the monomer represented by the above chemical formula (4) or (5) has the property of absorbing light having a wavelength of 330 nm or longer, the light utilization efficiency can be raised, and a PSA layer is sufficiently formed even by a short-time and single irradiation, and the residual DC voltage in the liquid crystal layer can be made to be hardly generated. Since the light irradiation can be finished in a short time, the deterioration of constituting members due to the long-time light irradiation can be prevented.

In the case where a PSA layer is formed using a compound represented by the above chemical formula (4) or (5), since the polymerization reaction is carried out using no polymerization initiator, the PSA layer exhibits no variation in the display property due to the influence of the residual unreacted polymerization initiator. Therefore, the generation of the image sticking in display due to the unreacted polymerization initiator can be reduced.

From the above, it was found that the formation of a PSA layer by using a bifunctional phenanthrene-based monomer represented by the above chemical formula (4) or (5) was effective for the improvement of the generation of after image of image sticking.

### Example 3

Hereinafter, Example 3 will be shown in which liquid crystal cells which the liquid crystal display devices according to Embodiment 1 had were each actually fabricated. First, a pair of support substrates were prepared; and a polyamic acid solution being a material for a vertical alignment film was applied on the respective surfaces of the pair of support substrates, and pre-baked under a condition of 80° C. for 5 min, and then post-baked under a condition of 200° C. for 60 min.

Then, the alignment films after the post-baking were subjected to an alignment treatment. Then, a sealant was applied on the one substrate; and a composition for forming a liquid crystal layer containing a liquid crystal material having a negative anisotropy of dielectric constant and monomers for forming a PSA layer was dropped on the one substrate; and thereafter, the other substrate was laminated.

In Example 3, the monomers represented by the following chemical formula (12) and the following chemical formula (6) are used. A compound represented by the following chemical formula (12) is a phenanthrene-based bifunctional methacrylate monomer; and a compound represented by the following chemical formula (6) is a biphenyl-based bifunctional methacrylate monomer.

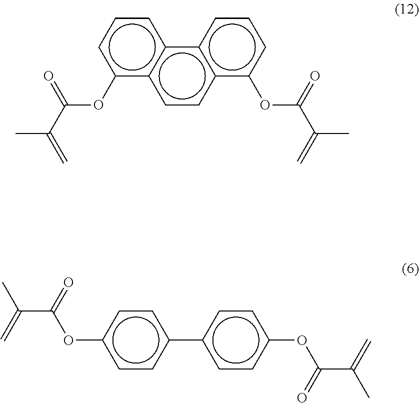

In order to fabricate the liquid crystal cell shown in Example 3, the compound represented by the above chemical formula (12) to be used as a monomer for forming a PSA layer was synthesized. The above compound was synthesized according to a method shown hereinafter, but the method is not limited thereto.

### Synthesis Example 3

### Synthesis of 1,8-dimethacryloyloxyphenanthrene (the Above Chemical Formula (12)))

1,8-Dimethacryloyloxyphenanthrene as a target substance was obtained by the same method as in the above Synthesis Example 1, except for using 2-bromobenzyl bromide in [Step 1] in the above Synthesis Example 1.

The analysis result of the obtained compound is as follows, and the compound was confirmed to be 1,8-dimethacryloyloxyphenanthrene by ¹H-NMR.

¹H-NMR (CDCl₃, ppm): δ=2.17 (s, 6H, methyl group), 5.87 (s, 2H, vinyl group), 6.53 (s, 2H, vinyl group), 7.43 (d, 2H, phenanthrene ring), 7.68 (t, 2H, phenanthrene ring), 7.84 (s, 2H, phenanthrene ring), 8.60 (d, 2H, phenanthrene ring)

FIG. 6 is a graph showing absorption spectra of compounds represented by the above chemical formula (12) and the above chemical formula (6), and a transmission spectrum of a usual alignment film-formed substrate. A compound represented by the above chemical formula (6) absorbs light of shorter wavelengths with a wavelength of 320 nm as the upper limit. On the other hand, a compound represented by the above chemical formula (12) absorbs light of shorter wavelengths with a wavelength of 365 nm as the upper limit. Therefore, the compound represented by the above chemical formula (12) can absorb light of wavelengths of 330 to 365 nm, which is not absorbed by the compound represented by the above chemical formula (6), and can be said to have a wider absorption wavelength range than the compound represented by the above chemical formula (6).

Samples prepared in Example 3 are the following Samples G and H. Sample G contains 0.6 wt % of a bifunctional phenanthrene-based monomer represented by the above chemical formula (12) in a composition for forming a liquid crystal layer. Sample H contains 0.3 wt % of a bifunctional biphenyl-based monomer represented by the above chemical formula (6) in a composition for forming a liquid crystal layer (the same as the above Sample C).

Then, the liquid crystal layer sandwiched between the pair of substrates was irradiated with black light (ultraviolet light having a peak wavelength in 300 to 370 nm) in a state in which a voltage was not impressed to carry out the polymerization reaction to thereby complete each liquid crystal cell in which a PSA layer was formed on the vertical alignment film. The irradiation time of ultraviolet rays to Sample G was set for 30 min, and that to Sample H was set for 60 min. As an ultraviolet light source, FHF-32BLB made by Toshiba Lighting & Technology Corp. was used.

Then, for each completed liquid crystal cell, the residual DC voltage (mV) was measured. Hereinafter, the results of the measurement of the residual DC voltage for each Sample are shown. Table 3 shows the measurement results of the residual DC voltage (mV) using the above each Sample. In Example 3, the value of a residual DC voltage is determined by using a flicker minimizing method after a DC offset voltage of 2 V is impressed for 10 hours.

TABLE 3

| | | Residual DC voltage |
|---|---|---|
| | Composition weight ratio | (mV) |
| Sample G | Chemical formula (12) - 0.6 | −40 |
| | wt % | |
| Sample H | Chemical formula (6) - 0.3 | 170 |
| | wt % | |

Use of the composition containing 0.6 wt % of a bifunctional phenanthrene-based monomer represented by the above chemical formula (12) made the residual DC voltage −40 mV, and attained an improving effect of after image of image sticking. This is because the use of a bifunctional phenanthrene-based monomer represented by the above chemical formula (12) can raise the polymerization velocity by ultraviolet light irradiation, forms a PSA layer by ultraviolet rays irradiation in a shorter time than conventionally, and prevents the deterioration of constituting members.

In the case of the composition containing 0.3 wt % of a bifunctional biphenyl-based monomer represented by the above chemical formula (6), a long-time irradiation with ultraviolet light (for example, 10 hours or longer) was necessary and the irradiation for 60 min could not form a stable PSA layer, and the residual DC voltage was 170 mV.

Since the monomer represented by the above chemical formula (12) has the property of absorbing light having a wavelength of 330 nm or longer, the light utilization efficiency can be raised, and a PSA layer is sufficiently formed even by a short-time and single irradiation, and the residual DC voltage in the liquid crystal layer can be made to be hardly generated. Since the light irradiation can be finished in a short time, the deterioration of constituting members due to the long-time light irradiation can be prevented.

In the case where a PSA layer is formed using a compound represented by the above chemical formula (12), since the polymerization reaction is carried out using no polymerization initiator, the PSA layer exhibits no variation in the display property due to the influence of the residual unreacted polymerization initiator. Therefore, the generation of the image sticking in display due to the unreacted polymerization initiator can be reduced.

Additionally since the monomer represented by the above chemical formula (12) has a higher solubility in the liquid crystal than the monomer represented by the above chemical formula (6), a PSA layer can be formed by dissolving the monomer in a high concentration in the liquid crystal, effectively providing an improving effect of the residual DC voltage by the formation of the PSA layer.

From the above, it was found that the formation of a PSA layer by using a bifunctional phenanthrene-based monomer represented by the above chemical formula (12) was effective for the improvement of the generation of after image of image sticking.

### Example 4

Hereinafter, Example 4 will be shown in which liquid crystal cells which the liquid crystal display devices according to Embodiment 1 had were each actually fabricated. Each Sample of the liquid crystal cell used in Example 4 is fabricated by the same method as in Example 3, except for not subjecting the alignment film to an alignment treatment, and carrying out the irradiation with light in a state in which a voltage equal to or higher than a threshold value is impressed when a PSA layer is formed.

Samples prepared in Example 4 are the following Samples I and J. Sample I contains 0.6 wt % of a bifunctional phenanthrene-based monomer represented by the above chemical formula (12) in a composition for forming a liquid crystal layer. Sample J contains 0.3 wt % of a bifunctional biphenyl-based monomer represented by the above chemical formula (6) in a composition for forming a liquid crystal layer.

Then, the liquid crystal layer sandwiched between the pair of substrates was irradiated with black light (ultraviolet light having a peak wavelength in 300 to 370 nm) in a state in which a voltage (a square wave voltage of 5 V and 30 Hz) equal to or higher than a threshold value was impressed to carry out the polymerization reaction to thereby complete each liquid crystal cell in which a PSA layer was formed on the vertical alignment film. The irradiation time of ultraviolet rays to Sample I was set for 30 min, and that to Sample J was set for 60 min. As an ultraviolet light source, FHF-32BLB made by Toshiba Lighting & Technology Corp. was used.

Then, for each completed liquid crystal cell, the residual DC voltage (mV) was measured. Hereinafter, the results of the measurement of the residual DC voltage for each Sample are shown. Table 4 shows the measurement results of the residual DC voltage (mV) using the above each Sample. In Example 4, the value of a residual DC voltage is determined by using a flicker minimizing method after a DC offset voltage of 2 V is impressed for 10 hours.

TABLE 4

| | | Residual DC voltage |
|---|---|---|
| | Composition weight ratio | (mV) |
| Sample I | Chemical formula (12) - 0.6 | −50 |
| | wt % | |
| Sample J | Chemical formula (6) - 0.3 | 190 |
| | wt % | |

Use of the composition containing 0.6 wt % of a bifunctional phenanthrene-based monomer represented by the above chemical formula (12) made the residual DC voltage −50 mV, and attained an improving effect of after image of image sticking. This is because the use of a bifunctional phenanthrene-based monomer represented by the above chemical formula (12) can raise the polymerization velocity by ultraviolet light irradiation, forms a PSA layer by ultraviolet rays irradiation in a shorter time than conventionally, and prevents the deterioration of constituting members.

From the above, it was found that the formation of a PSA layer by using a bifunctional phenanthrene-based monomer represented by the above chemical formula (12) was effective for the improvement of the generation of after image of image sticking.

The present application claims priority to Patent Application No. 2010-174502 filed in Japan on August, 2010 under the Paris Convention and provisions of national law in a designated State, the entire contents of which are hereby incorporated by reference.

### REFERENCE SIGNS LIST

1: ARRAY SUBSTRATE
2: COLOR FILTER SUBSTRATE
3: LIQUID CRYSTAL LAYER
4: MONOMER
11, 21: SUPPORT SUBSTRATE
12, 22: ALIGNMENT FILM
13, 23: PSA LAYER (POLYMER LAYER)

1.-7. (canceled)

8. A liquid crystal display device comprising: a pair of substrates; and a liquid crystal layer sandwiched between the pair of substrates,
wherein the liquid crystal layer comprises a liquid crystal material;
at least one of the pair of substrates has an alignment film to control the alignment of adjacent liquid crystal molecules, and a polymer layer formed on the alignment film and to control the alignment of adjacent liquid crystal molecules;
the polymer layer is a polymer layer formed by polymerizing one or two or more monomers added in the liquid crystal layer; and
at least one of the monomers is a phenanthrene derivative represented by the following chemical formula (1): 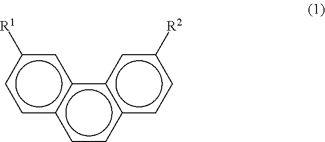
wherein R¹ and R² are identical or different, and each denote an -Sp-P group, a hydrogen atom, a halogen atom, a —CN group, a —NO₂ group, a —NCO group, a —NCS group, an —OCN group, a —SCN group, a —SF₅ group, or a straight-chain or branched-chain alkyl group having 1 to 12 carbon atoms; at least one of R¹ and R² denotes an -Sp-P group; P denotes a polymerizable group; Sp denotes a straight-chain, branched-chain or cyclic alkylene group or alkyleneoxy group having 1 to 6 carbon atoms, or a direct bond of both groups interposing Sp; a hydrogen atom which R¹ and R² have may be replaced by a fluorine atom or a chlorine atom; and a —CH₂— group which R¹ and R² have, unless oxygen atoms, sulfur atoms and nitrogen atoms are mutually adjacent, may be substituted with an —O— group, a —S— group, a —NH— group, a —CO— group, a —COO— group, a —OCO— group, an —O—COO— group, a —OCH₂— group, a —CH₂O— group, a —SCH₂— group, a —CH₂S— group, a —N(CH₃)— group, a —N(C₂H₅)— group, a —N(C₃H₇)— group, a —N(C₄H₉)— group, a —CF₂O— group, a —OCF₂— group, a —CF₂S— group, a —SCF₂— group, a —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, or a —OCO—CH═CH— group.

9. A liquid crystal display device comprising: a pair of substrates; and a liquid crystal layer sandwiched between the pair of substrates,
wherein the liquid crystal layer comprises a liquid crystal material;
at least one of the pair of substrates has an alignment film to control the alignment of adjacent liquid crystal molecules, and a polymer layer formed on the alignment film and to control the alignment of adjacent liquid crystal molecules;
the polymer layer is a polymer layer formed by polymerizing one or two or more monomers added in the liquid crystal layer; and
at least one of the monomers is a phenanthrene derivative represented by the following chemical formula (2): 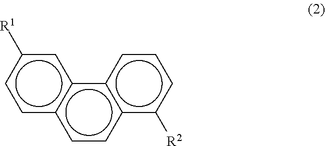
wherein R¹ and R² are identical or different, and each denote an -Sp-P group, a hydrogen atom, a halogen atom, a —CN group, a —NO₂ group, a —NCO group, a —NCS group, an —OCN group, a —SCN group, a —SF₅ group, or a straight-chain or branched-chain alkyl group having 1 to 12 carbon atoms; at least one of R¹ and R² denotes an -Sp-P group; P denotes a polymerizable group; Sp denotes a straight-chain, branched-chain or cyclic alkylene group or alkyleneoxy group having 1 to 6 carbon atoms, or a direct bond of both groups interposing Sp; a hydrogen atom which R¹ and R² have may be replaced by a fluorine atom or a chlorine atom; and a —CH₂— group which R¹ and R² have, unless oxygen atoms, sulfur atoms and nitrogen atoms are mutually adjacent, may be substituted with an —O— group, a —S— group, a —NH— group, a —CO— group, a —COO— group, a —OCO— group, an —O—COO— group, a —OCH₂— group, a —CH₂O— group, a —SCH₂— group, a —CH₂S— group, a —N(CH₃)— group, a —N(C₂H₅)— group, a —N(C₃H₇)— group, a —N(C₄H₉)— group, a —CF₂O— group, a —OCF₂— group, a —CF₂S— group, a —SCF₂— group, a —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, or a —OCO—CH═CH— group.

10. A liquid crystal display device comprising: a pair of substrates; and a liquid crystal layer sandwiched between the pair of substrates,
wherein the liquid crystal layer comprises a liquid crystal material;
at least one of the pair of substrates has an alignment film to control the alignment of adjacent liquid crystal molecules, and a polymer layer formed on the alignment film and to control the alignment of adjacent liquid crystal molecules;
the polymer layer is a polymer layer formed by polymerizing one or two or more monomers added in the liquid crystal layer; and
at least one of the monomers is a phenanthrene derivative represented by the following chemical formula (3): 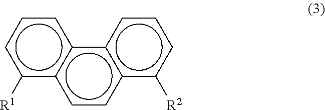
wherein R¹ and R² are identical or different, and each denote an -Sp-P group, a hydrogen atom, a halogen atom, a —CN group, a —NO₂ group, a —NCO group, a —NCS group, an —OCN group, a —SCN group, an —SF₅ group, or a straight-chain or branched-chain alkyl group having 1 to 12 carbon atoms; at least one of R¹ and R² denotes an -Sp-P group; P denotes a polymerizable group; Sp denotes a straight-chain, branched-chain or cyclic alkylene group or alkyleneoxy group having 1 to 6 carbon atoms, or a direct bond of both groups interposing Sp; a hydrogen atom which R¹ and R² have may be replaced by a fluorine atom or a chlorine atom; and a —CH₂— group which R¹ and R² have, unless oxygen atoms, sulfur atoms and nitrogen atoms are mutually adjacent, may be substituted with an —O— group, a —S— group, a —NH— group, a —CO— group, a —COO— group, a —OCO— group, an —O—COO— group, a —OCH₂— group, a —CH₂O— group, a —SCH₂— group, a —CH₂S— group, a —N(CH₃)— group, a —N(C₂H₅)— group, a —N(C₃H₇)— group, a —N(C₄H₉)— group, a —CF₂O— group, a —OCF₂— group, a —CF₂S— group, a —SCF₂— group, a —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, or a —OCO—CH═CH— group.

11. The liquid crystal display device according to claim 8,
wherein the P denotes an acryloyloxy group, a methacryloyloxy group, an acryloylamino group, or a methacryloylamino group.

12. The liquid crystal display device according to claim 8,
wherein the R¹ and R² are identical or different, and each denote an -Sp-P group; and
one or both of the Sp denote a direct bond of both groups interposing the Sp.

13. The liquid crystal display device according to claim 8,
wherein the R¹ and R² are identical or different, and each denote an acryloxy group or a methacryloxy group.

14. The liquid crystal display device according to claim 8,
wherein the liquid crystal material has a negative anisotropy of dielectric constant.

15.-23. (canceled)
